(19) United States
(12) Patent Application Publication
(10) Pub. No.: US 2014/0137135 A1
(43) Pub. Date: May 15, 2014

(54) MULTI-CORE-BASED LOAD BALANCING DATA PROCESSING METHODS

(71) Applicant: TAEJIN INFO TECH CO., LTD., Seoul (KR)

(72) Inventor: Dong-Ju Lee, Seoul (KR)

(73) Assignee: TAEJIN INFO TECH CO., LTD., Seoul (KR)

(21) Appl. No.: 13/678,259

(22) Filed: Nov. 15, 2012

(51) Int. Cl. G06F 9/50

(52) U.S. Cl. CPC G06F 9/505
USPC 718/105

(57) ABSTRACT

Systems and methods for processing data are provided. A system can include a plurality of cores and a core manager. A load balancing unit can check and compare loads of the cores. An address mapping unit can perform a mapping process based on the loads of the cores, and the core manager can route data appropriately, thereby improving the overall performance of the system.

### BACKGROUND

Input/output devices receive data and store the data within the device. Conventional virtualized input/output devices combine multiple storage devices as a single disk. The data converges on a single disk, leading to diminished data-writing performance of the disk and thereby inhibiting the overall performance of the device.

### BRIEF SUMMARY

Embodiments of the subject invention relate to advantageous data processing methods, systems for efficiently processing data, and methods of fabricating the same. A multi-core-based load balancing data processing method can utilize address re-mapping based on load status of each core in order to have the least-loaded core process data. As a result, the load of each core could be minimized, thereby improving the overall performance and efficiency of the system and the method.

In an embodiment, a system can include: a plurality of cores; a core manager in operable communication with the plurality of cores and configured to manage the plurality of cores; a load balancing unit in operable communication with the plurality of cores and configured to check a load of each core of the plurality of cores; and an address mapping unit in operable communication with the load balancing unit and the core manager and configured to perform a mapping process of data based on the loads of the cores.

In another embodiment, a method of process data can include: receiving data into a system; analyzing loads of a plurality cores of the system to determine the least-loaded core having the smallest load; performing an address mapping process; and routing the data to the least-loaded core.

In yet another embodiment, a method of fabricating a system can include: fabricating a plurality of cores; fabricating a core manager configured to manage the plurality of cores; fabricating a load balancing unit configured to check a load of each core of the plurality of cores; fabricating an address mapping unit configured to perform a mapping process of data based on the loads of the cores; providing the core manager in operable communication with the plurality of cores and the address mapping unit; and providing the load balancing unit in operable communication with the plurality of cores and the address mapping unit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a schematic of a system according to an embodiment of the subject invention.

### DETAILED DISCLOSURE

Embodiments of the subject invention relate to advantageous data processing methods, systems for efficiently processing data, and methods of fabricating the same. A multi-core-based load balancing data processing method can utilize address re-mapping based on load status of each core in order to have the least-loaded core process data. As a result, the load of each core could be minimized, thereby improving the overall performance and efficiency of the system and the data processing method.

In an embodiment, a system can have a plurality of cores for processing data. The system can be configured to have the least-loaded core process data by address re-mapping based on current load status of each core of the plurality of cores. Thus, the load of each core can be decreased, and the performance of writing data to the system can be improved. In a particular embodiment, each core can be connected to a storage device. Each storage device can be a computer readable medium, though embodiments are not limited thereto. As a result, the load on each storage device can also be minimized or decreased. The system can be, e.g., a computer system.

In an embodiment, a system can include a plurality of cores and a core manager for managing the plurality of cores.

In a further embodiment, the system can include at least one external interface and at least one internal interface. The internal interface(s) can be in operable communication with one or more storage devices. That is, the internal interface(s) can be physically connected, electrically connected, directly electrically connected (i.e., electrically connected with no intervening components), and/or in wireless communication with one or more storage devices. For example, the internal interface(s) can be physically coupled to one or more storage devices. Each storage device can be a computer readable medium, though embodiments are not limited thereto. In a particular embodiment, each storage device can correspond to a different core of the plurality of cores and can be in operable communication with a corresponding internal interface.

In an embodiment, the external interface of the system can be connected to an external computing device, for example, a host computer (e.g., a host PC). The external interface can be connected to the external computing device by any suitable means known in the art, for example, though a high-speed communication network. The external interface can be physically connected to the external computing device (e.g., by wires) or the external interface can be connected to the external computing device wirelessly.

In an embodiment, the system can include a data processing unit for, e.g., performing data read and/or write operations. The system can further include a load balancing unit for determining the least-loaded core of the plurality of cores and an address mapping unit. In an alternative embodiment, the core manager can perform the function of the load balancing unit.

In an embodiment, the external interface can provide a physical interface with an external computing device (e.g., a host PC) through a high-speed communication line. The load balancing unit can compare loads of the cores, and the address mapping unit can perform a mapping of data to a new address. The new address can be, for example, the address of the least-loaded core. The address mapping unit can then forward the new address to the core manager, and the core manager can send data to the data processing unit. The data processing unit can perform data read/write to a storage device through the internal interface. Thus, a system of the subject invention can improve storage performance by decreasing the load on each core and processing data in parallel by distributing resources to multiple storage devices. Each component of the system can be in operable communication with any or all other components of the system.

Conventional virtualized input/output (I/O) devices combine multiple storage devices as a single disk, thereby reducing data-writing performance of the disk when loads converge on the device. In an embodiment of the subject invention, though, each core of a plurality of cores can correspond to a different storage device. Data can be processed by performing address re-mapping to the least-loaded core of the plurality of cores after analyzing the load of each core. Thus, load concentrations on a specific storage device can be inhibited, thereby maximizing performance during a data writing process.

Embodiments of the subject invention improve performance of a system when writing data by inhibiting loads from converging on a single core and/or a single storage device through load distribution and address re-mapping using a system having multiple cores.

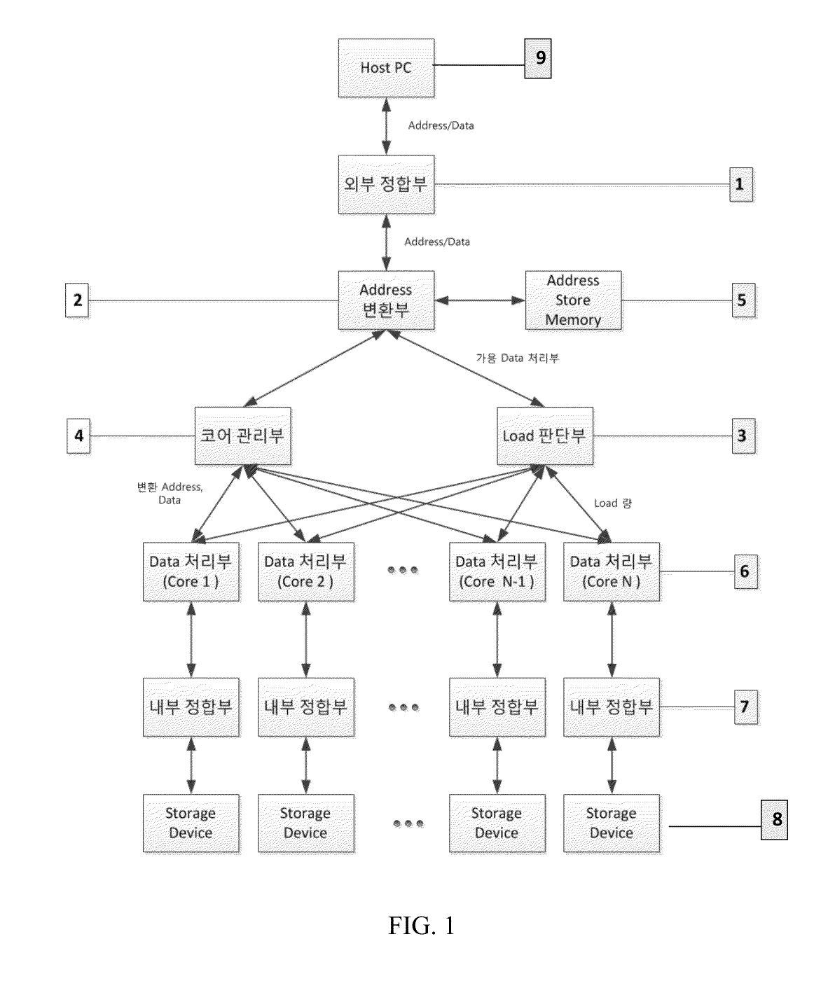

FIG. 1 shows a schematic of a system according to an embodiment of the subject invention. Referring to FIG. 1, in an embodiment, a system can include a plurality of cores 6 and a core manager 4 for managing the plurality of cores 6. The system can also include a load balancing unit 3, which can check the load of the cores 6 and look for a suitable core to process data. For example, the load balancing unit 3 can continuously check the load of the cores 6 and look for a suitable core to process data. When data is available for processing, the load balancing unit 3 can identify the core with the smallest load (i.e., the least-loaded core). The system can include an address mapping unit 2 which can perform a mapping of data to a new address. The new address can be, for example, the address of the least-loaded core. The load balancing unit 3 can compare loads of the cores 6, and the address mapping unit 2 can perform a mapping of data to a new address. The address mapping unit 2 can then forward the new address to the core manager 4, and the core manager 4 can send data to a core, for example the least-loaded core. The cores 6 can also include or be referred to as data processing units. In a particular embodiment, the system can also include a memory device 5, which can store addresses of the address mapping unit 2 before and/or after mapping.

In an embodiment, the system can also include one or more internal interfaces 7, and the internal interfaces 7 can be in operable communication with one or more storage devices 8. That is, the internal interface(s) 7 can be physically connected, electrically connected, directly electrically connected, and/or in wireless communication with the one or more storage devices 8. For example, the internal interface(s) 7 can be physically coupled to the one or more storage devices 8. Each storage device can be a computer readable medium, though embodiments are not limited thereto. In a particular embodiment, each internal interface 7 can be in operable communication with a core 6 and a storage device 8. That is, each storage device 8 can correspond to a different core 6 of the plurality of cores and can be in operable communication with a corresponding internal interface 7.

In an embodiment, the system can also include an external interface 1. The external interface 1 of the system can be in operable communication with (e.g., physically connected to, electrically connected to, directly electrically connected to, and/or in wireless communication with) an external computing device 9, for example, a host computer (e.g., a host PC). The external interface 1 can be connected to the external computing device 9 by any suitable means known in the art, for example, though a high-speed communication network. The external interface 1 can be physically connected to the external computing device 9 (e.g., by wires) or the external interface 1 can be connected to the external computing device 9 wirelessly. In a particular embodiment, the external interface 1 can provide a physical interface with the external computing device 9 (e.g., a host PC) through a high-speed communication line.

In certain embodiments, the load balancing unit 3 can compare loads of the cores 6, and the address mapping unit 2 can perform a mapping of data to a new address. The address mapping unit 2 can then forward the new address to the core manager 4, and the core manager 4 can send data to the data processing unit (e.g., the least-loaded core 6). The data processing unit can perform data read/write to a storage device 8 through the internal interface 7. Thus, a system of the subject invention can improve storage performance by decreasing the load on each core 6 and processing data in parallel by distributing resources to multiple storage devices 8. Each core of a plurality of cores 6 can correspond to a different storage device 8. Data can be processed by performing address re-mapping to the least-loaded core of the plurality of cores 6 after analyzing the load of each core. Thus, load concentrations on a specific storage device can be inhibited, thereby maximizing performance during a data writing process. In a particular embodiment, a memory device 5 can be included and can store addresses of the address mapping unit 2 before and/or after mapping.

In an embodiment, a data processing method can include analyzing loads of a plurality of cores and re-mapping addresses to send data to the least-loaded core of the plurality of cores. A system (e.g., a computer system) for performing the method can include a load balancing unit for checking (e.g., continuously checking) the plurality of cores. For example, the load balancing unit can compare loads of the cores with each other. The system can include an address mapping unit which can perform a mapping of data to a new address. The new address can be, for example, the address of the least-loaded core. The address mapping unit can then forward the new address to the core manager, and the core manager can send data to a core, for example, the least-loaded core. Each core can also include or be referred to as a data processing unit. In a particular embodiment, the system can also include a memory device, and the method can include storing addresses of the address mapping unit before and/or after mapping. Each component of the system can be in operable communication with any or all of the other components of the system.

In an embodiment, the method can include sending data from the cores to one or more storage devices. Each storage device can be a computer readable medium, though embodiments are not limited thereto. The system can include one or more internal interface(s) in operable communication with the plurality of cores and/or the one or more storage devices. In a particular embodiment, each internal interface can be in operable communication with a core and a storage device. That is, each storage device can correspond to a different core of the plurality of cores and can be in operable communication with a corresponding internal interface. The system can also include an external interface configured to be in operable communication with an external computing device (e.g., a host PC). In a particular embodiment, the external interface is in communication with the external computing device, and the system receives data to be processed from the external computing device.

In an embodiment, a method of fabricating a system can include fabricating a plurality of cores, fabricating a core manager, fabricating an address mapping unit, fabricating a load balancing unit, providing the core manager in operable communication with the plurality of cores and the address mapping unit, and providing the load balancing unit in operable communication with the plurality of cores and the address mapping unit. The load balancing unit can compare loads of the cores with each other, and the address mapping unit can perform a mapping of data to a new address. The new address can be, for example, the address of the least-loaded core. The address mapping unit can then forward the new address to the core manager, and the core manager can send data to a core, for example, the least-loaded core.

In an embodiment, the method of fabricating the system can also include fabricating an external interface and/or one or more internal interfaces and/or one or more storage devices. Each storage device can be a computer readable medium, though embodiments are not limited thereto. The external interface can be provided in operable communication with the address mapping unit. The external interface can also be configured to be in operable communication with an external computing device (e.g., a host PC). The internal interface(s) can be provided in operable communication with the plurality of cores and can be configured to be in operable communication with one or more storage devices or can actually be in operable communication with the one or more storage devices. In a particular embodiment, each internal interface can be in operable communication with a core and a storage device. That is, each storage device can correspond to a different core of the plurality of cores and can be in operable communication with a corresponding internal interface.

In a particular embodiment, the method can also include fabricating a memory device and providing the memory device in operable communication with the address mapping unit. The memory device can store addresses of the address mapping unit before and/or after mapping.

The computer system (and/or external computing device) can have hardware including one or more computer processing units (CPUs), memory, mass storage (e.g., hard drive), and I/O devices (e.g., network interface, user input devices). Elements of the computer system hardware can communicate with each other via a bus.

The computer system hardware can be configured according to any suitable computer architectures such as a Symmetric Multi-Processing (SMP) architecture or a Non-Uniform Memory Access (NUMA) architecture. The one or more CPUs may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

In accordance with certain embodiments of the invention, the network may be any suitable communications network including, but not limited to, a cellular (e.g., wireless phone) network, the Internet, a local area network (LAN), a wide area network (WAN), a WiFi network, or a combination thereof. Such networks are widely used to connect various types of network elements, such as routers, servers, and gateways. It should also be understood that the invention can be practiced in a multi-network environment having various connected public and/or private networks. As will be appreciated by those skilled in the art, communication networks can take several different forms and can use several different communication protocols.

Certain techniques set forth herein may be described in the general context of computer-executable instructions, such as program modules, executed by one or more computers or other devices. Certain embodiments of the invention contemplate the use of a computer system or virtual machine within which a set of instructions, when executed, can cause the system to perform any one or more of the methodologies discussed above. Generally, program modules include routines, programs, objects, components, and data structures that perform particular tasks or implement particular abstract data types.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data. Computer-readable media should not be construed or interpreted to include any propagating signals.

Of course, the embodiments of the invention can be implemented in a variety of architectural platforms, devices, operating and server systems, and/or applications. Any particular architectural layout or implementation presented herein is provided for purposes of illustration and comprehension only and is not intended to limit aspects of the invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A system, comprising:
a plurality of cores;
a core manager in operable communication with the plurality of cores and configured to manage the plurality of cores;
a load balancing unit in operable communication with the plurality of cores and configured to check a load of each core of the plurality of cores; and
an address mapping unit in operable communication with the load balancing unit and the core manager and configured to perform a mapping process of data based on the loads of the cores.

2. The system according to claim 1, further comprising at least one internal interface in operable communication with at least one core of the plurality of cores.

3. The system according to claim 2, further comprising at least one storage device in operable communication with the at least one internal interface.

4. The system according to claim 3, wherein each core of the plurality of cores is in operable communication with a corresponding internal interface, and wherein each internal interface is in operable communication with a corresponding storage device.

5. The system according to claim 1, wherein the load balancing unit is configured to determine the least-loaded core,
wherein the address mapping unit is configured to generate a data address corresponding to the least-loaded core for the data mapping process,
wherein the address mapping unit is configured to forward the data address to the core manager, and
wherein the core manager is configured to send data to the least-loaded core based on the data address received from the address mapping unit.

6. The system according to claim 1, further comprising an external interface in operable communication with the address mapping unit and configured to be in operable communication with an external computing device.

7. The system according to claim 1, further comprising a memory device in operable communication with the address mapping unit and configured to store addresses from the address mapping unit.

8. A method of processing data, comprising:
receiving data into a system;
analyzing loads of a plurality cores of the system to determine the least-loaded core having the smallest load;
performing an address mapping process; and
routing the data to the least-loaded core.

9. The method according to claim 8, wherein performing the address mapping process comprises generating a data address corresponding to the least-loaded core.

10. The method according to claim 8, wherein the system comprises:
a load balancing unit in operable communication with the plurality of cores; and
an address mapping unit in operable communication with the load balancing unit,
wherein the load balancing unit analyzes loads of the plurality of cores to determine the least-loaded core,
wherein the address mapping unit performs the address mapping process.

11. The method according to claim 10, wherein the system further comprises a core manager in operable communication with the plurality of cores and the address mapping unit and configured to manage the plurality of cores,
wherein performing the address mapping process comprises generating a data address corresponding to the least-loaded core, and
wherein the address mapping unit forwards the data address to the core manager.

12. The method according to claim 11, wherein the core manager routes the data to the least-loaded core based on the data address received from the address mapping unit
a data address corresponding to the least-loaded core for the data mapping process

13. The method according to claim 10, wherein the system further comprises a plurality of internal interfaces and a plurality of storage devices,
wherein each core of the plurality of cores is in operable communication with a corresponding internal interface, and wherein each internal interface is in operable communication with a corresponding storage device

14. The method according to claim 13, wherein the data is sent through the least-loaded core through its corresponding internal interface and to its corresponding storage device.

15. The method according to claim 10, wherein the system further comprises an external interface in operable communication with the address mapping unit and configured to be in operable communication with an external computing device,
wherein the data is received through the external interface.

16. The method according to claim 10, wherein the system further comprises a memory device in operable communication with the address mapping unit,
wherein addresses from the address mapping unit are stored by the memory device.

17. A method of fabricating a system, comprising:
fabricating a plurality of cores;
fabricating a core manager configured to manage the plurality of cores;
fabricating a load balancing unit configured to check a load of each core of the plurality of cores;
fabricating an address mapping unit configured to perform a mapping process of data based on the loads of the cores;
providing the core manager in operable communication with the plurality of cores and the address mapping unit; and
providing the load balancing unit in operable communication with the plurality of cores and the address mapping unit.

18. The method according to claim 17, wherein the load balancing unit is configured to determine the least-loaded core,
wherein the address mapping unit is configured to generate a data address corresponding to the least-loaded core for the data mapping process,
wherein the address mapping unit is configured to forward the data address to the core manager, and
wherein the core manager is configured to send data to the least-loaded core based on the data address received from the address mapping unit.

19. The method according to claim 17, further comprising:
fabricating a plurality of internal interfaces each configured to be in operable communication with a storage device;
fabricating an external interface configured to be in operable communication with an external computing device; and
providing each core of the plurality of cores in operable communication with a corresponding internal interface of the plurality of internal interfaces.

20. The method according to claim 19, further comprising:
fabricating a plurality of storage devices; and
providing each internal interface of the plurality of internal interfaces in operable communication with a corresponding storage device of the plurality of storage devices.
